(19) United States
(12) Patent Application Publication
(10) Pub. No.: US 2021/0003818 A1
(43) Pub. Date: Jan. 7, 2021

(54) IMAGING LENS AND IMAGING APPARATUS

(71) Applicant: SONY SEMICONDUCTOR SOLUTIONS CORPORATION, KANAGAWA (JP)

(72) Inventor: TOMOHIKO BABA, KANAGAWA (JP)

(21) Appl. No.: 16/968,674

(22) PCT Filed: Feb. 1, 2019
(86) PCT No.: PCT/JP2019/003552

§ 371 Date: Aug. 10, 2020

(30) Foreign Application Priority Data
Feb. 16, 2018 (JP) 2018-025756

(51) Int. Cl. G02B 9/12; G02B 13/18

(52) U.S. Cl. CPC G02B 9/12; G02B 13/18

(57) ABSTRACT

The present disclosure relates to an imaging lens and an imaging apparatus allowing more optimization. The imaging lens includes a first lens, a second lens, and a third lens disposed from the object side toward the image side. An imaging device has a cover member made from a medium having a higher refractive index than air being joined directly onto the imaging surface. Then, a maximum chief ray incident on the cover member from the third lens exceeds 35°, and a maximum chief ray incident angle to the imaging surface is relaxed by 5° or more using the refractive index at the cover member. The present technology can be applied, for example, to an imaging apparatus required to be miniaturized.

### TECHNICAL FIELD

The present disclosure relates to an imaging lens and an imaging apparatus, and more particularly, relates to an imaging lens and an imaging apparatus that allow more optimization.

### BACKGROUND ART

As imaging lenses used with solid-state imaging devices such as charge-coupled device (CCD) and complementary metal-oxide semiconductor (CMOS) image sensors, imaging lenses having various characteristics have been developed.

For example, Patent Document 1 discloses an imaging lens in which a first lens having positive refractive power, a diaphragm, a second lens having positive refractive power, and a third lens having negative refractive power are disposed in the order from the object side, and which satisfies conditions described in Patent Document 1.

Furthermore, Patent Document 2 discloses an imaging lens in which a first lens having positive power, a diaphragm, a second lens having positive power, and a third lens having negative power at a central portion and having positive power at a peripheral portion are disposed in the order from the object side, and which satisfies first to third conditional expressions described in Patent Document 2.

Moreover, Patent Document 3 discloses a wide-angle lens in which a first lens that is a concave aspherical lens, a second lens that is a convex aspherical lens, and a third lens that is a convex aspherical lens are disposed in the order from the object side, and which satisfies first to third conditional expressions described in Patent Document 3.

### CITATION LIST

### Patent Document

Patent Document 1: Japanese Patent Application Laid-Open No. 2004-37960
Patent Document 2: Japanese Patent No. 5003120
Patent Document 3: Japanese Patent Application Laid-Open No. 2001-337268

### SUMMARY OF THE INVENTION

### Problems to be Solved by the Invention

By the way, imaging lenses as disclosed in Patent Documents 1 to 3 described above have been developed, but there are demands for imaging lenses optimized in combination with an imaging device with a cover member joined directly onto an imaging surface, for example.

The present disclosure has been made in view of such circumferences, and is intended to allow more optimization.

### Solutions to Problems

An imaging lens according to an aspect of the present disclosure includes a first lens, a second lens, and a third lens disposed from an object side toward an image side, in which a cover member made from a medium having a higher refractive index than air is joined directly onto an imaging surface of an imaging device, a maximum chief ray incident on the cover member from the third lens exceeds 35°, and a maximum chief ray incident angle to the imaging surface is relaxed by 5° or more using the refractive index at the cover member.

An imaging apparatus according to an aspect of the present disclosure includes an imaging lens including a first lens, a second lens, and a third lens disposed from an object side toward an image side, and an imaging device with a cover member made from a medium having a higher refractive index than air being joined directly onto an imaging surface, in which a maximum chief ray incident on the cover member from the third lens exceeds 35°, and a maximum chief ray incident angle to the imaging surface is relaxed by 5° or more using the refractive index at the cover member.

According to an aspect of the present disclosure, an imaging lens includes a first lens, a second lens, and a third lens disposed from an object side toward an image side, and an imaging device has a cover member made from a medium having a higher refractive index than air being joined directly onto an imaging surface. Then, a maximum chief ray incident on the cover member from the third lens exceeds 35°, and a maximum chief ray incident angle to the imaging surface is relaxed by 5° or more using the refractive index at the cover member.

### Effects of the Invention

According to an aspect of the present disclosure, more optimization can be achieved.

Note that the effects described here are not necessarily limiting, and any effect described in the present disclosure may be included.

### BRIEF DESCRIPTION OF DRAWINGS

FIG. 1 is a diagram schematically showing a configuration example of a first embodiment of an imaging lens to which the present technology is applied.

FIG. 2 is a diagram showing lens configuration data, aspherical surface data, and configuration data of the imaging lens of FIG. 1.

FIG. 3 is a diagram showing a configuration example of an imaging lens disclosed in Patent Document 2.

FIG. 4 is a diagram showing various aberrations in comparison.

FIG. 5 is a diagram showing the image height dependence of the MTF in comparison.

FIG. 6 is a diagram schematically showing a configuration example of a second embodiment of an imaging lens to which the present technology is applied.

FIG. 7 is a diagram showing lens configuration data, aspherical surface data, and configuration data of the imaging lens of FIG. 6.

FIG. 8 is a diagram showing various aberrations of the imaging lens of FIG. 6.

FIG. 9 is a diagram showing the image height dependence of the MTF of the imaging lens of FIG. 6.

FIG. 10 is a diagram schematically showing a configuration example of a third embodiment of an imaging lens to which the present technology is applied.

FIG. 11 is a diagram showing lens configuration data, aspherical surface data, and configuration data of the imaging lens of FIG. 10.

FIG. 12 is a diagram showing a configuration example of an imaging lens disclosed in Patent Document 3.

FIG. 13 is a diagram showing various aberrations in comparison.

FIG. 14 is a diagram schematically showing a configuration example of a fourth embodiment of an imaging lens to which the present technology is applied.

FIG. 15 is a diagram showing lens configuration data, aspherical surface data, and configuration data of the imaging lens of FIG. 14.

FIG. 16 is a diagram showing various aberrations of the imaging lens of FIG. 14.

FIG. 17 is a diagram showing the image height dependence of the MTF of the imaging lens of FIG. 14.

FIG. 18 is a block diagram showing a configuration example of an imaging apparatus.

FIG. 19 is a diagram showing usage examples of using the imaging apparatus.

### MODE FOR CARRYING OUT THE INVENTION

Hereinafter, specific embodiments to which the present technology is applied will be described in detail with reference to the drawings.

<First Configuration Example of Imaging Lens>

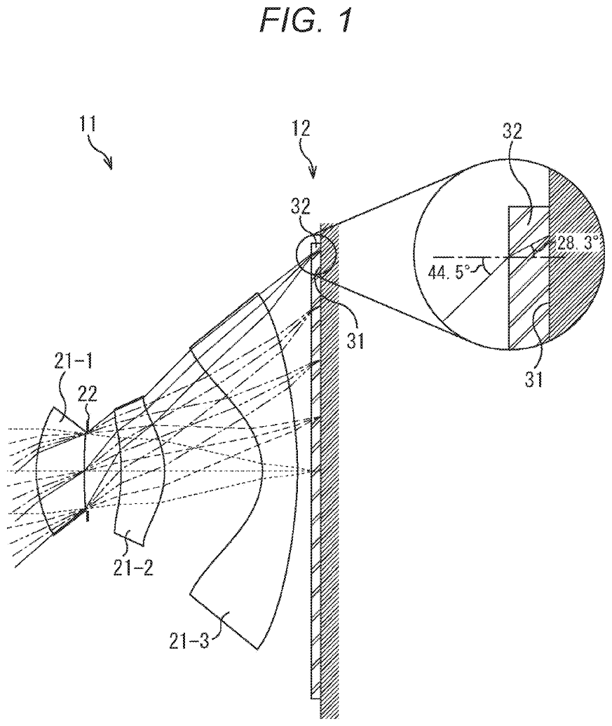

FIG. 1 is a diagram schematically showing a configuration example of a first embodiment of an imaging lens to which the present technology is applied.

For example, an imaging lens 11 shown in FIG. 1 is used by being mounted on an imaging apparatus for various mobile terminals, onboard cameras, mobile personal computers (PCs), wearable devices, scanners, surveillance cameras, action cams, video cameras, digital cameras, and so on. Furthermore, an imaging surface 31 of a solid-state imaging device 12 such as a CCD or CMOS image sensor is disposed in an image formation plane of the imaging lens 11. Moreover, a cover glass 32 and, additionally, various optical members (not shown) such as an infrared cut filter or a low-pass filter may be disposed between an image-side surface of an image-side lens group of the solid-state imaging device 12 and the imaging surface 31.

As shown in FIG. 1, the imaging lens 11 includes a first lens 21-1, a diaphragm 22, a second lens 21-2, and a third lens 21-3 disposed in the order from the object side toward the image-surface side. The first lens 21-1 has a positive refractive index and is of a meniscus shape having a convex surface on the object side. The second lens 21-2 has a positive refractive index. The third lens 21-3 has a negative refractive index from the center to the periphery, and is of a meniscus shape having a convex surface on the image side.

The solid-state imaging device 12 used in combination with the imaging lens 11 includes the cover glass 32 joined directly to the imaging surface 31 formed on a semiconductor substrate (without a space such as an air layer provided therebetween). The cover glass 32 is made from a material having a larger refractive index than air, and protects the imaging surface 31 of the solid-state imaging device 12. Furthermore, for a filler (adhesive) filling a space between the cover glass 32 and the imaging surface 31, one having a refractive index approximately equal to that of the cover glass 32 is used.

Consequently, light emitted from the third lens 21-3 and entering the cover glass 32 is refracted at the surface of the cover glass 32, and enters the imaging surface 31, substantially maintaining that angle. Here, for the purpose of obtaining the effect of refraction by the cover glass 32, the refractive index of the cover glass 32 is preferably larger than that of air. Note that as the material of the cover glass 32, a resin or the like other than glass may be used if the imaging surface 31 can be protected.

By using the imaging lens 11 and the solid-state imaging device 12 like this in combination and satisfying conditions as described below, the maximum chief ray angle of emission of the imaging lens 11 can be made larger than before.

First, as a first condition to be satisfied by the imaging lens 11 and the solid-state imaging device 12, the angle θcg of the maximum chief ray incident on the cover glass 32 from the third lens 21-3 is set to satisfy 35° or more (θcg>35°). Then, using the refractive index at the cover glass 32, the maximum chief ray incident angle to the imaging surface 31 is relaxed by 5° or more. For example, as shown enlarged on the right side of FIG. 1, the angle θcg of the maximum chief ray incident on the cover glass 32 is set to 44.5°, and the maximum chief ray incident angle to the imaging surface 31 is relaxed to 28.3°, using the refractive index at the cover glass 32.

For example, imaging apparatuses of a normal configuration have a general limit that the maximum chief ray angle of imaging lens emission is 35°. Therefore, the first condition like this is necessary for the imaging lens 11 to achieve performance exceeding such a limit.

As the second condition, with respect to the image-side focal length f of the entire optical system of the imaging lens 11, the image-side focal length f1 of the first lens 21-1 is set to satisfy 0.5≤f1/f≤100, the image-side focal length f2 of the second lens 21-2 satisfy 0.3≤f2/f≤1.0, and the image-side focal length f3 of the third lens 21-3 satisfy −1.0≤f3/f≤−0.3.

The second condition like this is necessary, for example, for the three-lens configuration of the first lens 21-1, the diaphragm 22, the second lens 21-2, and the third lens 21-3 to allow the final third lens 21-3 to throw up the chief ray. For example, the second lens 21-2 of a positive refractive index is disposed in front of the third lens 21-3 having a negative refractive index to cancel out aberration, and further forming a symmetrical shape across the diaphragm 22 is more advantageous in terms of eliminating aberration. For that, the first lens 21-1 has a positive refractive index.

First, in order for the maximum chief ray incident on the cover glass 32 to be 35° or more, the image-side focal length f3 of the third lens 21-3 needs to satisfy −1.0≤f3/f≤−0.3. Then, if the second lens 21-2 necessary for correcting the aberration has too large a positive refractive index, it becomes too sensitive to manufacturing errors, and if it has too small a refractive index, it cannot correct the aberration. For its positive refractive index, the image-side focal length f2 of the second lens 21-2 needs to satisfy 0.3≤f2/f≤1.0.

Furthermore, the first lens 21-1 desirably forms a symmetrical shape across the diaphragm 22, but basically, it is opposed to a configuration into which the second lens 21-2 and the third lens 21-3 are combined, and thus its refractive index is smaller than that of the second lens 21-2. Consequently, the upper limit (the value is smaller) of the refractive index that the first lens 21-1 can take is determined, and it can take the lower limit (the value is the upper limit) of the refractive index at which it is immediately before becoming a negative lens. Thus, the image-side focal length f1 of the first lens 21-1 needs to satisfy 0.5≤f1/f≤100.

As the third condition, the Abbe number υcg of the cover glass 32 is set to be larger than 55 (υcg>55).

For the third condition like this, for example, if the Abbe number of the cover glass 32 is smaller than 55, refractive index dispersion depending on wavelength becomes large, thus causing excess aberration in synergy with incidence at a large incident angle. To prevent this from deteriorating the modulation transfer function (MTF), the third condition is necessary.

As the fourth condition, the thickness Tcg of the cover glass 32 is set to be 0.3 mm or less (Tcg≤0.3 mm).

The fourth condition like this is because, for example, cameras for various mobile terminals, onboard cameras, etc. are required to be miniaturized, and it is required to reduce the thickness of the cover glass 32. For example, in order to satisfy resolution required in recent years, it is feared that aberration caused by the cover glass 32 being thick affects the MTF. Therefore, the fourth condition is necessary as an allowable limit against affecting the MTF.

As the fifth condition, the back focus Bf from the cover glass 32 to the imaging lens 11 is set to be 0.2 mm or less (Bf≤0.2 mm).

For the fifth condition like this, for example, a bright f-number has been required as a recent trend, and in order to achieve a bright f-number, the angle between the upper light ray and the lower light ray of light rays forming an image needs to be steep. For example, if the back focus is long, at least the effective diameter of the final lens needs to be large, whereas miniaturization is required of cameras for various mobile terminals, onboard cameras, etc., which are mutually contradictory. Therefore, a limit is placed also on the back focus, and thus the fifth condition is necessary.

The imaging lens 11 and the solid-state imaging device 12 satisfying these first to fifth conditions are optimized to have more preferable image formation performance. For example, the maximum chief ray angle is expanded, and a more compact optical system can be provided.

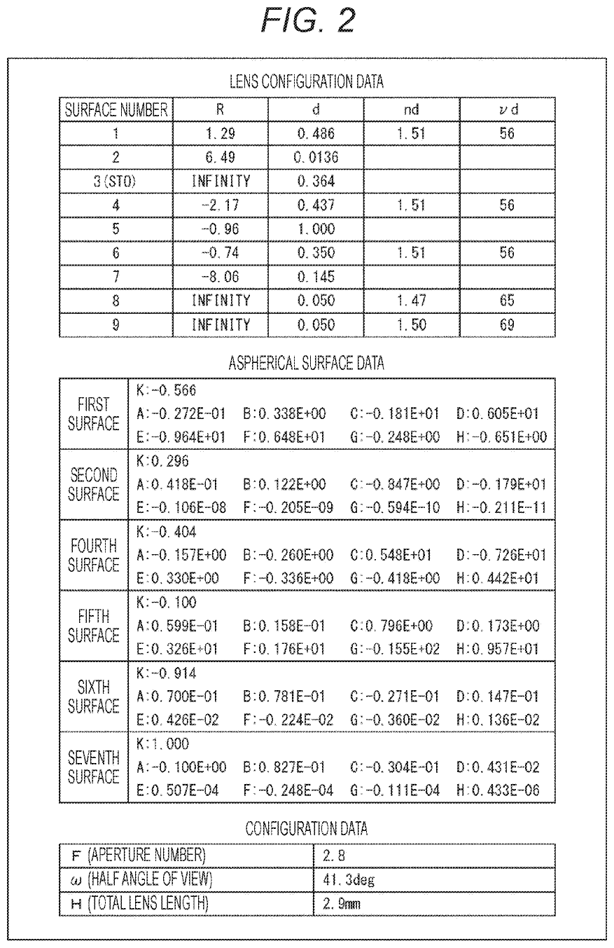

FIG. 2 shows a specific example of numerical values of the lens configuration data, the aspherical surface data, and the configuration data of the imaging lens 11. Here, FIG. 2 shows specific numerical values when the imaging lens 11 is applied to a CMOS image sensor used in an imaging apparatus mounted on a small mobile device such as a so-called smartphone, for example, a ¼-size, 2.2 μm-pixel-pitch, 2-megapixel CMOS image sensor.

Furthermore, the aspherical surface data shown in FIG. 2 is used in the following equation (1) representing the aspherical surfaces of the first lens 21-1, the second lens 21-2, and the third lens 21-3, where X is the distance from the tangent plane of the aspherical vertex of a coordinate point on an aspherical surface whose height from the optical axis is y, and c is the curvature of the aspherical vertex (1/r).

$$\begin{matrix} [ Equation 1 ] & \\ X = \frac{c {y}^{2}}{1 + \sqrt{1 - ( 1 + K ) {c}^{2} {y}^{2}}} + A {y}^{4} + {By}^{6} + C {y}^{8} + D {y}^{10} + E {y}^{12} + F {y}^{14} + G {y}^{16} + H {y}^{18} + J {y}^{20} & ( 1 )\end{matrix}$$

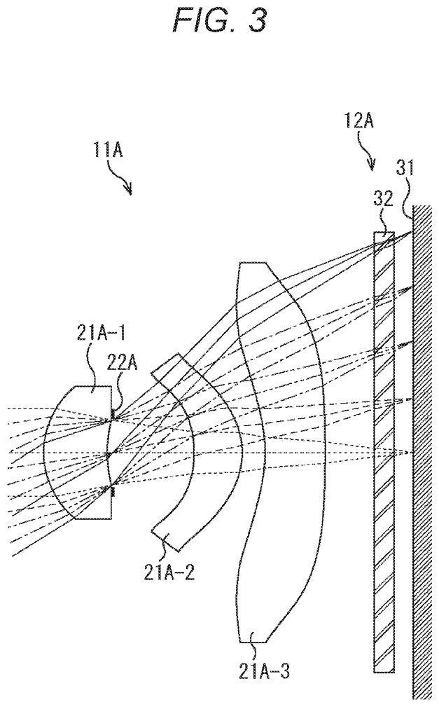

Here, for comparison with the imaging lens 11, FIG. 3 shows a configuration example of an imaging lens of a configuration based on the disclosure in Patent Document 2 described above.

As shown in FIG. 3, an imaging lens 11A includes a first lens 21A-1, a diaphragm 22A, a second lens 21A-2, and a third lens 21A-3 disposed in the order from the object side toward the image-surface side, and is assumed to be used in combination with a solid-state imaging device 12A with a space provided between an imaging surface 31 and a cover glass 32.

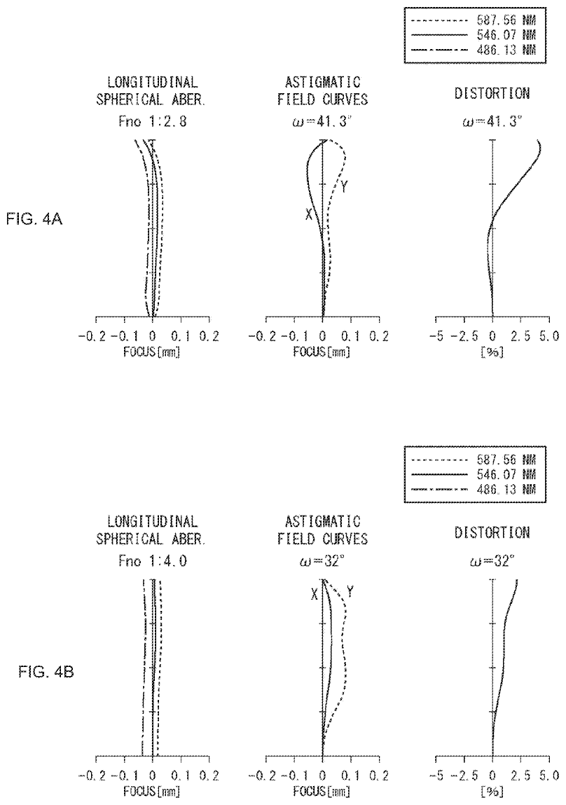

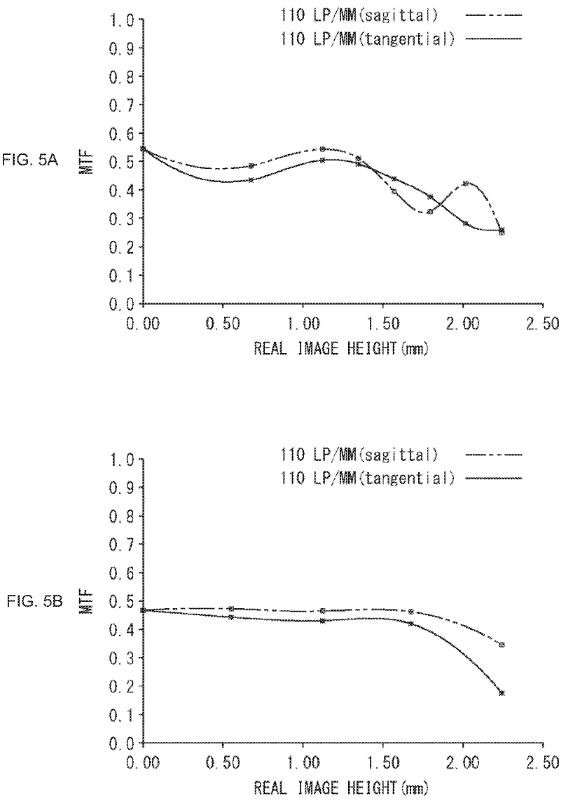

With reference to FIG. 4, various aberrations of the imaging lens 11 and the imaging lens 11A will be described. With reference to FIG. 5, the image height dependence of the MTF of the imaging lens 11 and the imaging lens 11A will be described.

A of FIG. 4 and A of FIG. 5 show various aberrations and the image height dependence of the MTF of the imaging lens 11. B of FIG. 4 and B of FIG. 5 show various aberrations and the image height dependence of the MTF of the imaging lens 11A. Note that for comparison in FIGS. 4 and 5, the imaging lens 11 and the imaging lens 11A are designed under similar limiting conditions.

For example, the imaging lens 11A of the configuration based on the disclosure in Patent Document 2 described above has a total optical length of 3.7 mm, and reduces the maximum chief ray incident angle with respect to the imaging surface 31 to 27°, achieving a half angle of view of 32°. Furthermore, in the MTF of white light of a frequency of 110 lps/mm, which is approximately half the Nyquist frequency of the 2.2 μm pixel pitch, the imaging lens 11A achieves 46.7% on the axis, and 45.0% meridional and 46.6% sagittal at the 70% increased height.

However, the imaging lens 11A has 27.9% meridional and 41.3% sagittal at the 90% increased height, and 17.6% meridional and 34.7% sagittal at the 100% increased height, deteriorating the MTF at peripheral image heights. That is because the third lens 21A-3 acts negatively at the center and acts positively at the periphery, so that if aberration is canceled out at the center, aberration cannot be canceled at the periphery. In actuality, it is balanced to some extent, and some aberration remains also at the center as well as at the periphery. Therefore, at an f-number of 4, a half angle of view of only up to 32° can be achieved.

By contrast, with the imaging lens 11 shown in FIG. 1, the chief ray angle of lens emission at the 100% increased height is 45.5°, and is refracted at the surface of the cover glass 32 and bent to 28.3°. Furthermore, with the imaging lens 11, the chief ray angle of lens emission becomes the largest, 47.3°, at the 90% increased height, and is refracted at the surface of the cover glass 32 and bent to 29.3° to be an incident angle desirable to the imaging surface 31.

These allow the imaging lens 11 to achieve a wide angle of a half angle of view of 41.3° with a bright lens of an f-number of 2.8 while keeping the total optical length as short as 2.9 mm in a ¼-size sensor. Furthermore, in the MTF of white light of a frequency of 110 lps/mm, which is approximately half the Nyquist frequency of the 2.2 μm pixel pitch, the imaging lens 11 can achieve 54.4% on the axis, 44.0% meridional and 39.7% sagittal at the 70% increased height, 28.3% meridional and 42.4% sagittal at the 90% increased height, and 25.3% meridional and 26.9% sagittal at the 100% increased height.

Consequently, as compared with the imaging lens 11A, the imaging lens 11 is shorter by 22% in the total optical length, is brighter by as much as 30%, and can also ensure a sufficient MTF at peripheral image heights. This can be achieved by the imaging lens 11 eliminating aberration by a positive-positive-negative configuration as a whole with the third lens 21-3 being a negative lens of a shape without undulations, allowing a chief ray angle of lens emission of up to 47.3°, increasing the degree of freedom in design, and relaxing to a light ray incident angle desirable to the imaging surface 31, using the refraction of the cover glass 32, to optimize the apparatus as a whole.

<Second Configuration Example of Imaging Lens>

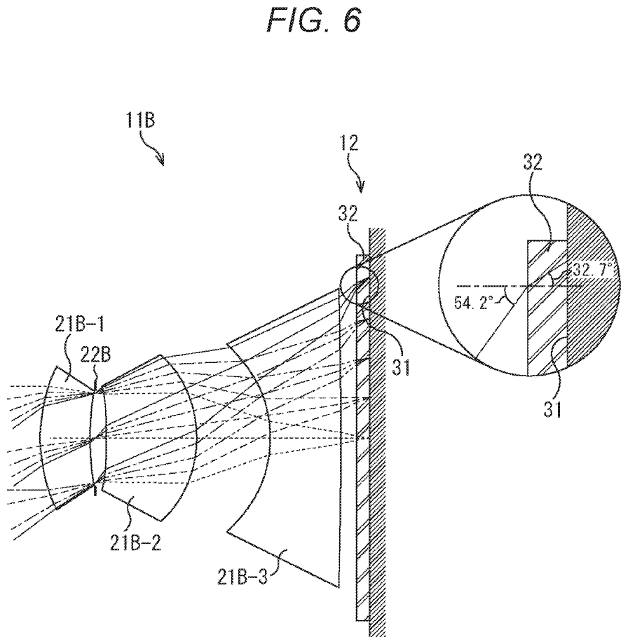

FIG. 6 is a diagram schematically showing a configuration example of a second embodiment of an imaging lens to which the present technology is applied. Furthermore, a solid-state imaging device 12 shown in FIG. 6 includes a cover glass 32 joined directly to an imaging surface 31 as in FIG. 1, and detailed description thereof will be omitted.

As shown in FIG. 6, the imaging lens 11B includes a first lens 21B-1, a diaphragm 22B, a second lens 21B-2, and a third lens 21B-3 disposed in the order from the object side toward the image-surface side. The first lens 21B-1 is a spherical glass that has a positive refractive index and is of a meniscus shape having a convex surface on the object side. The second lens 21B-2 is an aspherical glass having a positive refractive index. The third lens 21B-3 is a spherical glass that has a negative refractive index, and is of a meniscus shape having a convex surface on the image side.

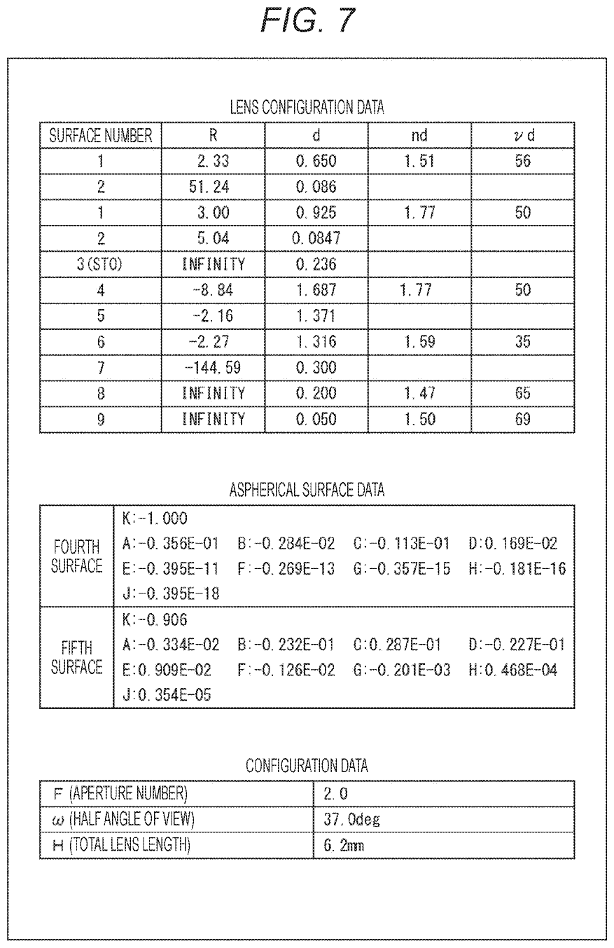

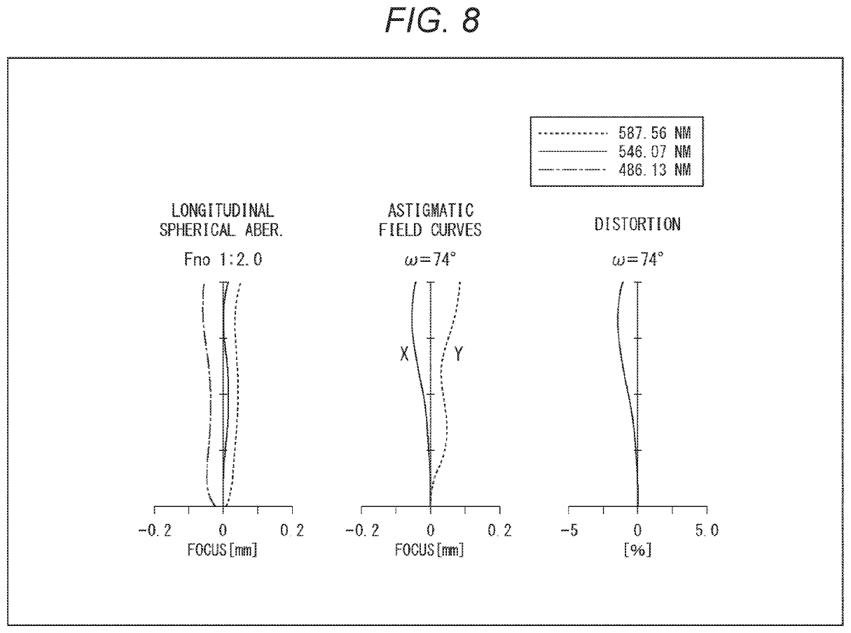

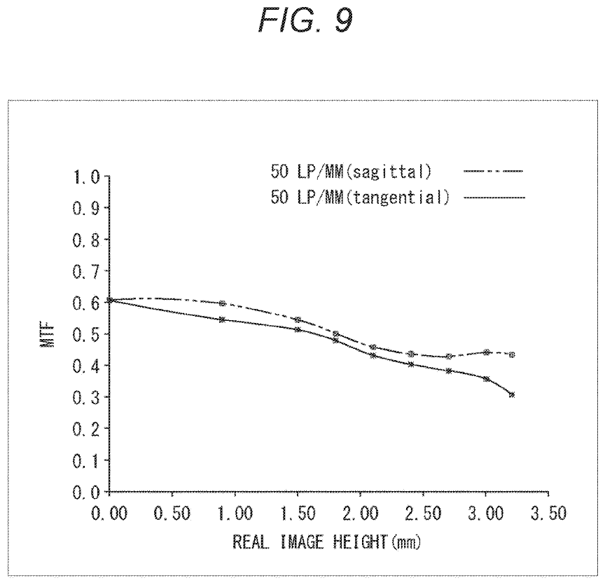

Furthermore, FIG. 7 shows a specific example of numerical values of the lens configuration data, the aspherical surface data, and the configuration data of the imaging lens 11B. Moreover, FIG. 8 shows various aberrations of the imaging lens 11B, and FIG. 9 shows the image height dependence of the MTF of the imaging lens 11B. Note that FIGS. 7 to 9 show specific numerical values when the imaging lens 11B is applied to a CMOS image sensor used in an imaging apparatus for onboard use, for example, a ⅓-size, 3.0 μm-pixel-pitch, 2-megapixel CMOS image sensor.

Then, as shown enlarged on the right side of FIG. 6, in the imaging lens 11B, the chief ray angle of lens emission is 54.2° at the 100% increased height, and is refracted at the surface of the cover glass 32 and bent to 32.7° to be an incident angle desirable to the imaging surface 31. These can achieve a wide angle of a half angle of view of 37° with brightness of an f-number of 2.0 while keeping the total optical length as short as 6.2 mm in a ⅓-size 2-megapixel CMOS image sensor.

By the way, it is said that for the replacement of a vehicle rearview mirror with a camera, it is optimum that the full angle of view is in the vicinity of 60°. This angle of view is a horizontal angle of view of 60° in a sensor with an effective-pixel aspect ratio of 4:3. Moreover, the replacement of a vehicle rearview mirror with a camera requires that performance does not deteriorate at ambient temperatures and that flare can be sufficiently prevented.

Thus, the imaging lens 11B uses glass lenses for all of the first lens 21B-1, the second lens 21B-2, and the third lens 21B-3 to be able to avoid performance deterioration at ambient temperatures. Moreover, glass lenses can be low-reflection coated, and thus the imaging lens 11B can prevent flare.

Furthermore, in terms of productivity, consideration is given to the imaging lens 11B by using one glass molded lens that is trouble-prone as the second lens 21B-2, and using two spherical lenses that are free from fatal troubles and can be produced stably as the first lens 21B-1 and the third lens 21B-3.

Basic characteristics equivalent to those of the imaging lens 11B have not been achieved by configurations using only one aspherical lens. By contrast, the imaging lens 11B can be achieved by eliminating aberration by a positive-positive-negative configuration as a whole, allowing a chief ray angle of lens emission of up to 54.2°, increasing the degree of freedom in design, and relaxing to a light ray incident angle desirable to the imaging surface 31, using the refraction of the cover glass 32, to optimize the apparatus as a whole.

<Third Configuration Example of Imaging Lens>

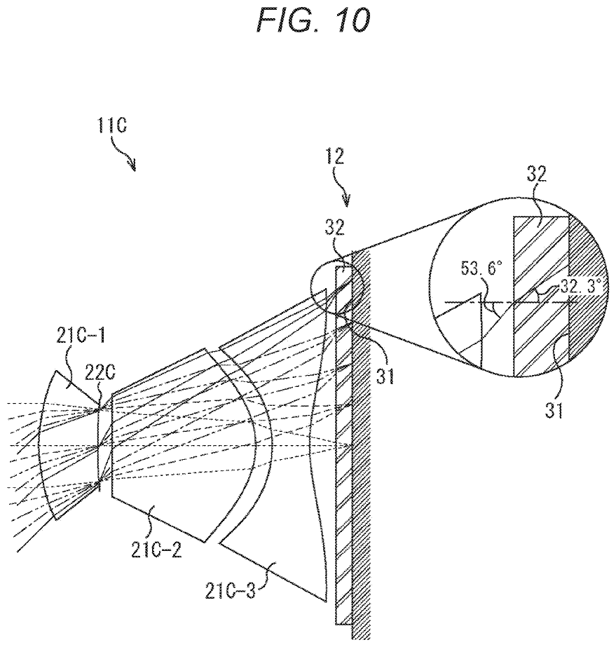

FIG. 10 is a diagram schematically showing a configuration example of a third embodiment of an imaging lens to which the present technology is applied. Furthermore, a solid-state imaging device 12 shown in FIG. 10 includes a cover glass 32 joined directly to an imaging surface 31 as in FIG. 1, and detailed description thereof will be omitted.

As shown in FIG. 10, an imaging lens 11C includes a first lens 21C-1, a diaphragm 22C, a second lens 21C-2, and a third lens 21C-3 disposed in the order from the object side toward the image-surface side. The first lens 21C-1 is a spherical glass that has a positive refractive index and is of a meniscus shape having a convex surface on the object side. The second lens 21B-2 is an aspherical glass having a positive refractive index. The third lens 21B-3 is an aspherical lens having a negative refractive index from the center to the periphery. Furthermore, the third lens 21B-3 is of an undulating shape in which the object-side surface is uniformly curved toward the object side as it goes to the periphery while the image side is uniformly curved toward the image side from the center to the middle or so, and is curved backward at the periphery, but acts uniformly negatively from the center to the periphery as the effect of the lens.

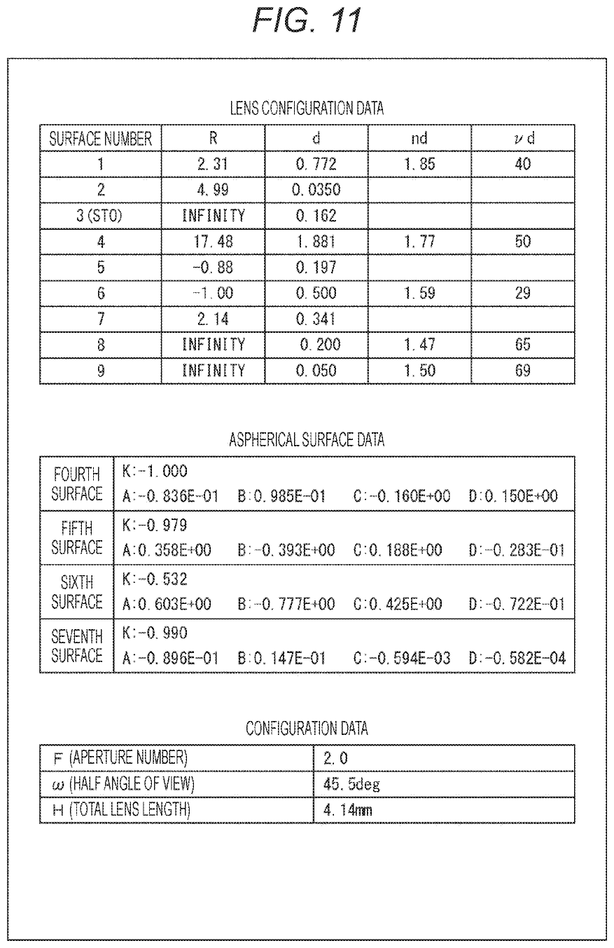

FIG. 11 shows a specific example of numerical values of the lens configuration data, the aspherical surface data, and the configuration data of the imaging lens 11C. Here, FIG. 11 shows specific numerical values when the imaging lens 11C is applied to a CMOS image sensor used in an imaging apparatus for onboard use, for example, a ¼-size, video graphics array (VGA)-standard CMOS image sensor.

As shown enlarged on the right side of FIG. 10, light emitted from the imaging lens 11C has a chief ray angle of lens emission of 53.6° at the 100% increased height, which is refracted at the surface of the cover glass 32 and bent to 32.3° to be an incident angle desirable to the imaging surface 31.

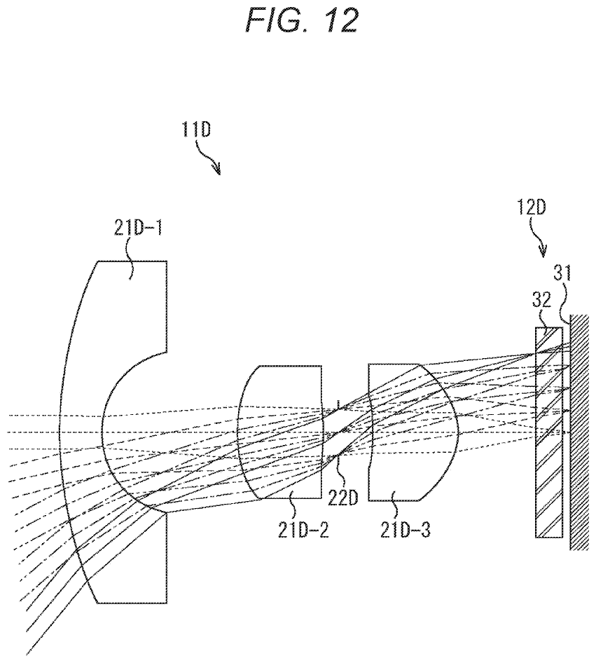

Here, for comparison with the imaging lens 11C, FIG. 12 shows a configuration example of an imaging lens of a configuration based on the disclosure in Patent Document 3 described above.

As shown in FIG. 12, an imaging lens 11D includes a first lens 21D-1, a second lens 21D-2, a diaphragm 22D, and a third lens 21D-3 disposed in the order from the object side toward the image-surface side, and is assumed to be used in combination with a solid-state imaging device 12D with a space provided between an imaging surface 31 and a cover glass 32.

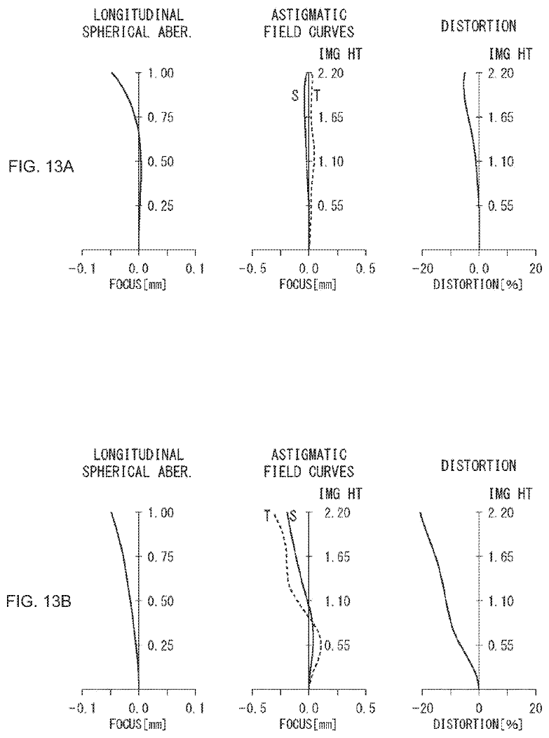

Moreover, A of FIG. 13 shows various aberrations of the imaging lens 11C, and B of FIG. 13 shows various aberrations of the imaging lens 11D. Note that for comparison in FIG. 13, the imaging lens 11C and the imaging lens 11D are designed under similar limiting conditions. For example, FIG. 13 shows specific numerical values when the imaging lens 11C and the imaging lens 11D are designed as an onboard camera module of a three-lens configuration (in a 90° camera category) of a CMOS image sensor used in an imaging apparatus for onboard use, and are applied, for example, to a ¼-size, VGA-standard CMOS image sensor.

For example, the imaging lens 11D based on the disclosure in Patent Document 3 described above includes a first lens 21D-1 of a glass material with a negative refractive index and low dispersion, a second lens 21D-2 of a glass material with a positive refractive index and high dispersion, a diaphragm 22D, and a third lens 21D-3 of a glass material with a positive refractive index and low dispersion in the order from the object side. With this, the imaging lens 11D achieves a focal length of 2.32 mm, an f-number of 2.8, and a total optical length of 13.2 mm.

Note that the imaging lens 11D performs achromatization by the second lens 21D-2 using a glass material with a positive refractive index and high dispersion, but using high dispersion with a negative lens generally has a higher achromatization effect. Therefore, the imaging lens 11D has a low aberration suppression effect as the entire configuration, and thus its optical length is longer and its f-number is only 2.8.

By contrast, the imaging lens 11C shown in FIG. 10 can achieve a bright lens with an f-number of 2.0 while keeping the total optical length as short as 4.14 mm in a ¼-size 90° camera. For example, as compared with the imaging lens 11D, the imaging lens 11C is ⅓ or less in the total optical length, and is 40% brighter in f-number. Furthermore, given the comparison between longitudinal aberration diagrams of the imaging lens 11C shown in A of FIG. 13 and longitudinal aberration diagrams of the imaging lens 11D shown in B of FIG. 13, the imaging lens 11C can reduce astigmatism and spherical aberration while preventing distortion.

This can be achieved by the imaging lens 11C eliminating aberration by a positive-positive-negative configuration, allowing a chief ray angle of lens emission of up to 53.6°, increasing the degree of freedom in design, and relaxing to a light ray incident angle desirable to the imaging surface 31, using the refraction of the cover glass 32, to optimize the apparatus as a whole.

<Fourth Configuration Example of Imaging Lens>

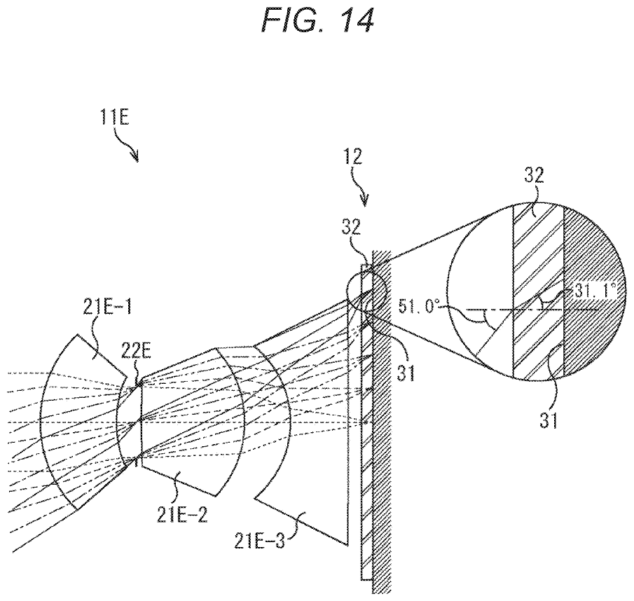

FIG. 14 is a diagram schematically showing a configuration example of a fourth embodiment of an imaging lens to which the present technology is applied. Furthermore, a solid-state imaging device 12 shown in FIG. 14 includes a cover glass 32 joined directly to an imaging surface 31 as in FIG. 1, and detailed description thereof will be omitted.

As shown in FIG. 14, an imaging lens 11E includes a first lens 21E-1, a diaphragm 22E, a second lens 21E-2, and a third lens 21E-3 disposed in the order from the object side toward the image-surface side. The first lens 21E-1 is an aspherical glass that has a positive refractive index and is of a meniscus shape having a convex surface on the object side. The second lens 21E-2 is a spherical glass having a positive refractive index. The third lens 21E-3 is a spherical lens that has a negative refractive index, and is of a meniscus shape having a convex surface on the image side.

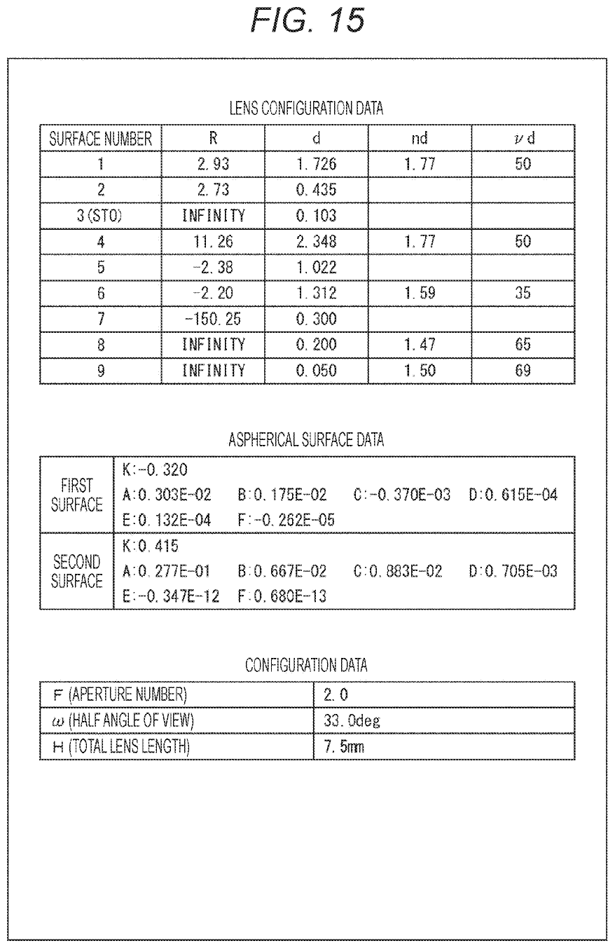

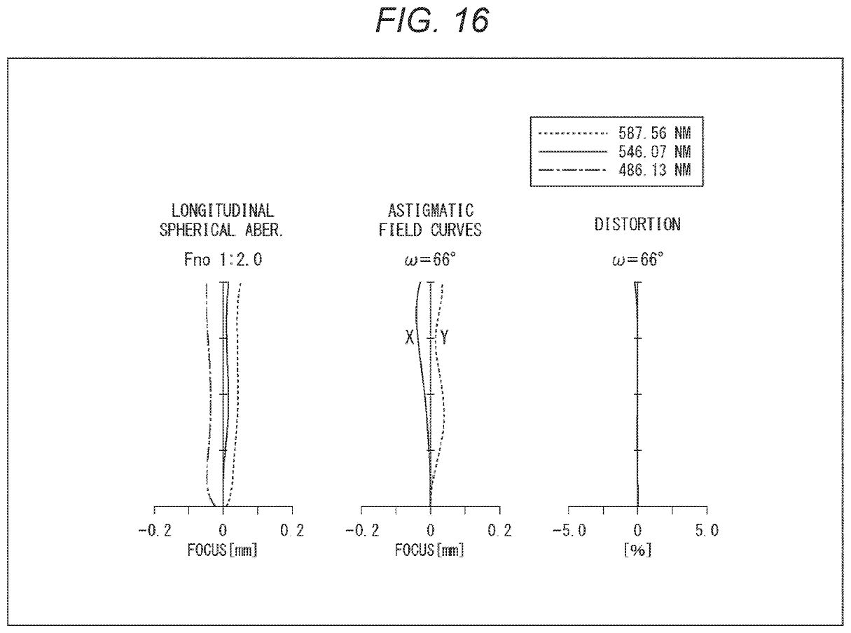

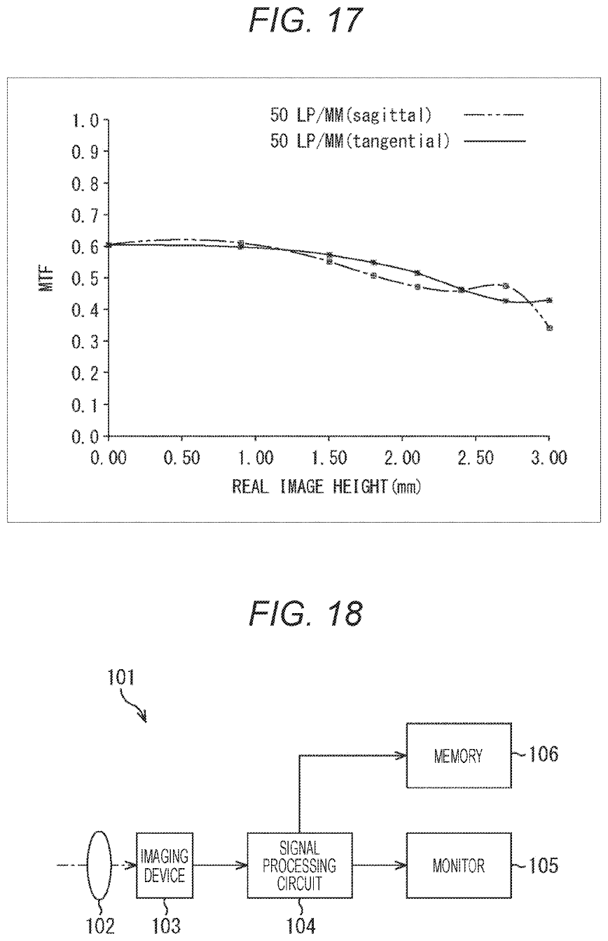

Furthermore, FIG. 15 shows a specific example of numerical values of the lens configuration data, the aspherical surface data, and the configuration data of the imaging lens 11E. Moreover, FIG. 16 shows various aberrations of the imaging lens 11E, and FIG. 17 shows the image height dependence of the MTF of the imaging lens 11E. Note that FIGS. 15 to 17 show specific numerical values when the imaging lens 11E is applied to a CMOS image sensor used in an imaging apparatus for onboard use, for example, a ⅓-size, 3.0 μm-pixel-pitch, 2-megapixel CMOS image sensor.

As shown enlarged on the right side of FIG. 14, light emitted from the imaging lens 11E has a chief ray angle of lens emission of 51.0° at the 100% increased height, and is refracted at the surface of the cover glass 32 and bent to 31.1° to be an incident angle desirable to the imaging surface 31. These can achieve a wide angle of a half angle of view of 33° with a bright lens of an f-number of 2.0 while keeping the total optical length as short as 7.5 mm in a ⅓-size 2-megapixel sensor.

By the way, it is said that for the replacement of a vehicle rearview mirror with a camera, it is optimum that the full angle of view is in the vicinity of 60°. This angle of view is a horizontal angle of view of 60° in a full high definition (HD)-standard sensor with an effective-pixel aspect ratio of about 2:1. Moreover, the replacement of a vehicle rearview mirror with a camera requires that performance does not deteriorate at ambient temperatures and that flare can be sufficiently prevented.

Thus, the imaging lens 11E uses glass lenses for all of the first lens 21E-1, the second lens 21E-2, and the third lens 21E-3 to be able to avoid performance deterioration at ambient temperatures. Moreover, glass lenses can be low-reflection coated, and thus the imaging lens 11E can prevent flare.

Furthermore, in terms of productivity, consideration is given to the imaging lens 11E by using one glass molded lens that is trouble-prone as the first lens 21E-1, and using two spherical lenses that are free from fatal troubles and can be produced stably as the second lens 21E-2 and the third lens 21E-3.

Basic characteristics equivalent to those of the imaging lens 11E have not been achieved by configurations using only one aspherical lens. By contrast, the imaging lens 11E can be achieved by eliminating aberration by a positive-positive-negative configuration as a whole, allowing a chief ray angle of lens emission of up to 51.0°, increasing the degree of freedom in design, and relaxing to a light ray incident angle desirable to the imaging surface 31, using the refraction of the cover glass 32, to optimize the apparatus as a whole.

As described above, the imaging lens 11 of the present embodiment (hereinafter, including the imaging lens 11B, the imaging lens 11C, and the imaging lens 11E) allows a lens steeper in the incident angle of the maximum chief ray from the imaging lens 11 to the cover glass 32 to be used by relaxing the incident angle to the imaging surface 31 using refraction by the cover glass 32. In particular, the imaging lens 11 is the most suitable configuration in an imaging apparatus that employs a three-lens configuration.

For example, in conventional imaging lenses, the light ray angle of lens emission is equal to the incident angle to the imaging device, and the incident angle limit of the imaging device is the light ray angle limit of lens emission. For example, in an electronic imaging device, a photoelectric conversion portion of each element is at a distance from a color filter that separates a color, so that light that has entered obliquely can enter an element different from an element with a color filter through which it has passed. As a result, a false color can be generated. Furthermore, the electronic imaging device has an incident angle limit because the efficiency of incident light is deteriorated by the structure and the action of an optical thin film forming it.

Moreover, in the case of conventional imaging apparatuses, here in particular, camera modules of a three-lens configuration using plastic a lot, the lens closest to the image side has concave action at the center and convex action at the periphery as an optimal solution. However, if the center has concave action and the periphery has convex action like this, aberration correction is not achieved at both the center and the periphery, and overall characteristics such as the total optical length, the angle of view, and the f-number are rate-limited by this aberration.

By contrast, the imaging lens 11 of the present embodiment is a three-lens-configuration camera module, and is used in combination with the solid-state imaging device 12 with the cover glass 32 stuck to the imaging surface 31 without an air space provided therebetween. At this time, by relaxing the incident angle to the imaging surface 31 using refraction by the cover glass 32, a lens steeper in the incident angle of the maximum chief ray from the imaging lens 11 to the cover glass 32 can be used. Thus, the imaging lens 11 can achieve high performance with a power arrangement of a positive-positive-negative configuration that is essentially advantageous in terms of aberration correction, and with the third lens 21-3 closest to the image side shaped to have negative action from the center to the periphery.

Specifically, as the imaging lens 11 of the present embodiment, the configuration example that achieves a total optical length of 2.9 mm in ¼ size has been described. Furthermore, the emission angle of the maximum chief ray from the imaging lens 11 can be set to 47° or more to facilitate aberration correction to achieve an unprecedented profile reduction.

Moreover, the imaging lens 11 of the present embodiment is suitable for use in applications in imaging apparatuses for onboard use.

For example, onboard cameras with a full angle of view of about 50° to 90° often use a three-lens-configuration lens. There has been no optimal configuration with three glasses, and most configurations have used plastic aspherical lenses. However, those are not suitable for applications such as replacement of side mirrors, which require high reliability.

By contrast, the imaging lens 11 of the present embodiment allows an unprecedentedly high chief ray angle of lens emission to increase design freedom in design, eliminates aberration in the positive-positive-negative configuration, and relaxes the angle to a light ray incident angle desirable to the imaging surface 31, using the refraction of the cover glass 32. Consequently, the imaging lens 11 of the present embodiment has a configuration suitable for application to an onboard lens of a three-glass configuration. Moreover, the imaging lens 11 of the present embodiment can be configured using only one glass molded lens that is trouble-prone and using two spherical lenses that can be stably produced as described above. Therefore, in terms of productivity, the imaging lens 11 of the present embodiment also allows introduction of a glass configuration to all the lenses without anxiety.

<Configuration Example of Electronic Equipment>

The imaging lens 11 and the solid-state imaging device 12 as described above can be applied, for example, to various types of electronic equipment including imaging systems such as digital still cameras and digital video cameras, mobile phones with an imaging function, or other devices with an imaging function.

FIG. 18 is a block diagram showing a configuration example of an imaging apparatus mounted on electronic equipment.

As shown in FIG. 18, an imaging apparatus 101 includes an optical system 102, an imaging device 103, a signal processing circuit 104, a monitor 105, and memory 106, and can capture still images and moving images.

The optical system 102, to which the above-described imaging lens 11 is applied, guides image light (incident light) from a subject to the imaging device 103, forming an image on a light-receiving surface (sensor portion) of the imaging device 103.

As the imaging device 103, the solid-state imaging device 12 described above is applied. Electrons are accumulated in the imaging device 103 for a certain period according to an image formed on the light-receiving surface via the optical system 102. Then, signals corresponding to the electrons accumulated in the imaging device 103 are provided to the signal processing circuit 104.

The signal processing circuit 104 performs various types of signal processing on pixel signals output from the imaging device 103. An image (image data) obtained by the signal processing circuit 104 performing the signal processing is provided to the monitor 105 to be displayed, or provided to the memory 106 to be stored (recorded).

The imaging apparatus 101 configured in this manner can capture, for example, higher-quality images by the application of the imaging lens 11 and the solid-state imaging device 12 described above.

<Examples of Use of Image Sensor>

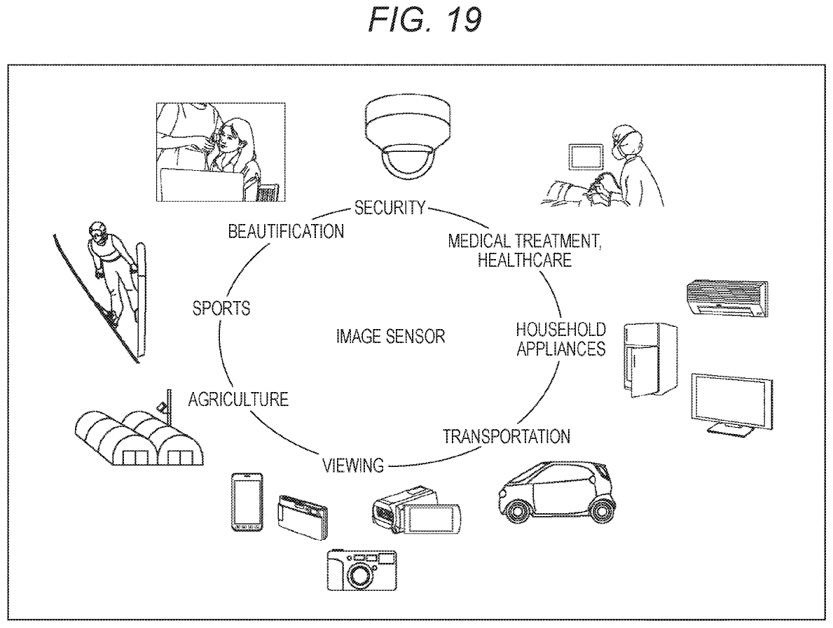

FIG. 19 is a diagram showing usage examples of using the above-described image sensor (camera module including the imaging lens 11 and the solid-state imaging device 12).

The above-described image sensor can be used in various cases where light such as visible light, infrared light, ultraviolet light, and X-rays are sensed as below, for example.

Apparatuses for capturing images for viewing, such as digital cameras and mobile devices with a camera function

Apparatuses for transportation use, such as onboard sensors for imaging the front, back, surroundings, interior, etc. of a vehicle, surveillance cameras for monitoring running vehicles and roads, and distance measurement sensors for measuring distance between vehicles or the like, for safe driving such as automatic stopping, recognition of a driver's conditions, and the like

Apparatuses used in household appliances such as TVs, refrigerators, and air conditioners, for imaging user gestures and performing device operations in accordance with the gestures

Apparatuses for medical treatment and healthcare use, such as endoscopes and apparatuses that perform blood vessel imaging through reception of infrared light

Apparatuses for security use, such as surveillance cameras for crime prevention applications and cameras for person authentication applications

Apparatuses for beautification use, such as skin measuring instruments for imaging skin and microscopes for imaging a scalp

Apparatuses for sports use, such as action cameras and wearable cameras for sports applications and the like

Apparatuses for agriculture use, such as cameras for monitoring the conditions of fields and crops

<Examples of Configuration Combinations>

Note that the present technology can also take on the following configurations.

(1)

An imaging lens including:

a first lens, a second lens, and a third lens disposed from an object side toward an image side,

in which a cover member made from a medium having a higher refractive index than air is joined directly onto an imaging surface of an imaging device, a maximum chief ray incident on the cover member from the third lens exceeds 35°, and a maximum chief ray incident angle to the imaging surface is relaxed by 5° or more using the refractive index at the cover member.

(2)

The imaging lens according to (1) above, in which

the first lens has positive refractive power,

the second lens has positive refractive power,

the third lens has negative refractive power, and

the imaging lens satisfies conditional expressions (1) to (3) below:

0.5≤f1/f≤100 (1)

0.3≤f2/f≤1.0 (2)

−1.0≤f3/f≤−0.3 (3)

where

f: an image-side focal length of an entire optical system

f1: an image-side focal length of the first lens

f2: an image-side focal length of the second lens

f3: an image-side focal length of the third lens.

(3)

The imaging lens according to (1) or (2) above, in which

the third lens has negative action from a center to a periphery.

(4)

The imaging lens according to any one of (1) to (3) above, in which

the cover member has an Abbe number of 55 or more, and the cover member has a thickness of 0.3 mm or less.

(5)

The imaging lens according to any one of (1) to (4) above, in which

a back focus from the cover member to the third lens is 0.2 mm or less.

(6)

An imaging apparatus including:

an imaging lens including a first lens, a second lens, and a third lens disposed from an object side toward an image side; and

an imaging device with a cover member made from a medium having a higher refractive index than air being joined directly onto an imaging surface,

in which a maximum chief ray incident on the cover member from the third lens exceeds 35°, and a maximum chief ray incident angle to the imaging surface is relaxed by 5° or more using the refractive index at the cover member.

Note that the present embodiments are not limited to the above-described embodiments, and various modifications can be made without departing from the scope of the present disclosure. Furthermore, the effects described in the present description are merely examples and non-limiting, and other effects may be included.

### REFERENCE SIGNS LIST

11 Imaging lens
12 Solid-state imaging device
21-1 First lens
21-2 Second lens
21-3 Third lens
22 Diaphragm
31 Imaging surface
32 Cover glass

1. An imaging lens comprising:
a first lens, a second lens, and a third lens disposed from an object side toward an image side,
wherein a cover member made from a medium having a higher refractive index than air is joined directly onto an imaging surface of an imaging device, a maximum chief ray incident on the cover member from the third lens exceeds 35°, and a maximum chief ray incident angle to the imaging surface is relaxed by 5° or more using the refractive index at the cover member.

2. The imaging lens according to claim 1, wherein
the first lens has positive refractive power,
the second lens has positive refractive power,
the third lens has negative refractive power, and
the imaging lens satisfies conditional expressions (1) to (3) below:
0.5≤f1/f≤100 (1)
0.3≤f2/f≤1.0 (2)
−1.0≤f3/f≤−0.3 (3)
where
f: an image-side focal length of an entire optical system
f1: an image-side focal length of the first lens
f2: an image-side focal length of the second lens
f3: an image-side focal length of the third lens.

3. The imaging lens according to claim 1, wherein
the third lens has negative action from a center to a periphery.

4. The imaging lens according to claim 1, wherein
the cover member has an Abbe number of 55 or more, and the cover member has a thickness of 0.3 mm or less.

5. The imaging lens according to claim 1, wherein
a back focus from the cover member to the third lens is 0.2 mm or less.

6. An imaging apparatus comprising:
an imaging lens comprising a first lens, a second lens, and a third lens disposed from an object side toward an image side; and
an imaging device with a cover member made from a medium having a higher refractive index than air being joined directly onto an imaging surface,
wherein a maximum chief ray incident on the cover member from the third lens exceeds 35°, and a maximum chief ray incident angle to the imaging surface is relaxed by 5° or more using the refractive index at the cover member.
